(19) United States
(12) Patent Application Publication
(10) Pub. No.: US 2025/0373127 A1
(43) Pub. Date: Dec. 4, 2025

(54) FIBER RETAINER, ELECTRICALLY CONDUCTIVE RING FOR BEARING ELECTRICAL CORROSION PROTECTION, AND ELECTRIC MOTOR

(71) Applicant: MPT NEWTECH SHANGHAI CO., LTD., Shanghai (CN)

(72) Inventors: Huanfeng LIU, Shanghai (CN); Zheshi LIU, Shanghai (CN); Fangwen JIN, Shanghai (CN); Feng WANG, Shanghai (CN); Shuangyi HUANG, Shanghai (CN); Baihua GU, Shanghai (CN)

(73) Assignee: MPT NEWTECH SHANGHAI CO., LTD., Shanghai (CN)

(21) Appl. No.: 18/876,546

(22) PCT Filed: Jun. 20, 2023
(86) PCT No.: PCT/CN2023/101443

§ 371 Date: Dec. 18, 2024

(30) Foreign Application Priority Data
Jun. 22, 2022 (CN) 202221574892.2

(51) Int. Cl. H02K 11/40

(52) U.S. Cl. CPC H02K 11/40

(57) ABSTRACT

Disclosed in the invention is a fiber retainer, comprising a body. The body internally has a fiber accommodating hole provided along the length thereof, and the fiber accommodating hole is used for accommodating an electrically conductive fiber. The body comprises an anti-separation portion and a fixing portion, wherein the fixing portion and the anti-separation portion constitute the body, and the anti-separation portion has an outer diameter greater than that of the fixing portion. The fiber accommodating hole is formed at least inside the fixing portion and extends to an end of the body; and the fixing portion deforms after being subjected to an external force, so that an inner diameter of part of the fiber accommodating hole is reduced, thereby fixing the electrically conductive fiber in the body. The fiber retainer fixes an electrically conductive fiber by means of the fixing portion thereof, and provides an axial binding force.

### TECHNICAL FIELD

The present invention relates to the field of bearing protection rings and electric motors, and more particularly to a fiber retainer, an electrically conductive ring for bearing electrical corrosion protection, and an electric motor.

### BACKGROUND ART

At present, in the process of using the electric motor, the motor is protected by the bearing protection device to to solve the problem of electric corrosion of the motor bearing. The bearing protection device can effectively control the shaft voltage and bearing current and protect the bearing.

However, most of the existing designs of bearing protection devices have the defects of inconvenient assembly and high cost. Thus, it is necessary to design a new structure to solve the existing deficiencies.

Patent document CN113178980A discloses a shaft grounding bearing protection device and an electric motor, including: a device body, wherein the device body is annular, and a side wall thereof is provided with at least one mounting hole; the direction of the opening of the mounting hole is a first direction which is towards the center of the device body, and the mounting hole penetrates radially along the device body; an electrically conductive ring, wherein the electrically conductive fiber passes through the mounting hole so as to be arranged on the device body, and the extension direction of the electrically conductive fiber is towards the center of the device body; wherein when the electrically conductive fiber passes through the mounting hole, the device body is deformed by adjusting a pressing force in a second direction of the mounting hole, so as to achieve the pressing of the electrically conductive fiber and the device body, the second direction being perpendicular to the first direction. However, the design still has the disadvantages of multiple procedures, complicated processing and being not suitable for mass production.

### SUMMARY OF THE INVENTION

In view of the deficiencies of the prior art, it is an object of the present invention to provide a fiber retainer, an electrically conductive ring for bearing electrical corrosion protection, and an electric motor.

In a first aspect of the invention, a fiber retainer is provided, including a body, wherein the body internally has a fiber accommodating hole provided along the length thereof, and the fiber accommodating hole is used for accommodating an electrically conductive fiber; the body includes an anti-separation portion and a fixing portion, wherein the fixing portion and the anti-separation portion constitute the body, and the anti-separation portion has an outer diameter greater than that of the fixing portion; the fiber accommodating hole is formed at least inside the fixing portion and extends to an end of the body; and the fixing portion deforms after being subjected to an external force, so that an inner diameter of part of the fiber accommodating hole is reduced, thereby fixing the electrically conductive fiber in the body.

Alternatively, the anti-separation portion is located substantially at an end of the body and the fixing portion is located substantially at a middle of the body.

Alternatively, an open end of the body has an R angle; and the electrically conductive fibers extend outwardly from the open end of the body.

Alternatively, the anti-separation portion includes a first anti-separation ring and a second anti-separation ring; and the fixing portion is located between the first anti-separation ring and the second anti-separation ring.

Alternatively, the second anti-separation ring is located at a front end of the body, and an open end of the second anti-separation ring has an R angle.

Alternatively, a first stress groove is provided between the first anti-separation ring and the fixing portion; a second stress groove is provided between the fixing portion and the second anti-separation ring; and the first stress groove and the second stress groove are both used to absorb the deformation generated by pressing the fixing portion.

Alternatively, the first stress groove and the second stress groove have a length ranging from 4 mm to 4.2 mm.

Alternatively, the fixing portion is a cylinder or a polygonal cylinder.

Alternatively, the fiber accommodating hole extends through the body or is a solid hole in the body.

Alternatively, only one anti-separation portion is provided.

Alternatively, the fixing portion is deformed by an external force and has at least a polygonal cross-section.

Alternatively, the fiber retainer further includes an electrically conductive fiber; the fiber accommodating hole extends through the body; at least one end of the electrically conductive fiber extends outwardly along the length of the body; and the body is electrically conductive.

According to a second aspect of the present invention, a fiber retainer is provided, including a body having a fiber accommodating hole extending in a length direction for accommodating an electrically conductive fiber; a first anti-separation ring, a fiber fixing ring, and a second anti-separation ring are sequentially arranged in a circumferential direction of the body in the length direction of the body; a first stress groove is provided between the first anti-separation ring and the fiber fixing ring; a second stress groove is provided between the fiber fixing ring and the second anti-separation ring; and the first stress groove and the second stress groove are both used for absorbing deformation generated by pressing the fiber fixing ring.

According to a third aspect of the present invention an electrically conductive ring for bearing electrical corrosion protection is provided, including a ring-shaped support and a housing, wherein the housing is matingly mounted on the ring-shaped support; the ring-shaped support is provided with at least one mounting groove for fixing the fiber retainer according to the first aspect of the present invention or the second aspect of the present invention.

Alternatively, the mounting grooves are provided with a plurality of ones arranged along a circumference of the ring-shaped support; and an axial direction of the fiber retainer is substantially the same as a radial direction of the ring-shaped support.

Alternatively, the mounting groove includes a first recess adapted to a fixing portion of the fiber retainer and a second recess adapted to an anti-separation portion of the fiber retainer.

Alternatively, the diameter of the second recess is slightly greater than the diameter of the first recess.

Alternatively, the upper surface of the anti-separation portion of the fiber retainer is slightly higher than the ring-shaped support, and the anti-separation portion includes a ring-shaped support and a housing; the housing is matingly mounted to the ring-shaped support; and the ring-shaped support is provided with at least one mounting groove being in close contact therewith.

Alternatively, the fiber retainer is fixed with an electrically conductive fiber; a tail end of the electrically conductive fiber is in interference contact with; including a ring-shaped support and a housing; the housing is matingly mounted to the ring-shaped support; the ring-shaped support is provided with at least one mounting groove; the mounting groove is in interference contact; the tail end of the fiber retainer is in interference contact with the ring-shaped support including a ring-shaped support and a housing; the housing is matingly mounted to the ring-shaped support; and the ring-shaped support is provided with at least one mounting groove, the mounting groove being in interference contact.

Alternatively, the electrically conductive ring for bearing electrical corrosion protection includes a plurality of ring-shaped supports arranged in layers within the electrically conductive ring for bearing electrical corrosion protection.

According to a fourth aspect of the present invention an electrically conductive ring for bearing electrical corrosion protection is provided, including a ring-shaped support and a cover plate, the cover plate is matingly mounted to the ring-shaped support, the both being together enclosed to form at least one mounting groove which is arranged in a radial direction of the ring-shaped support; the mounting groove is adapted to receive the fiber retainer of either the first aspect of the invention or the second aspect of the invention.

Alternatively, the cover plate extends with a plurality of anti-separation fasteners arranged in an annular space towards one side of the ring-shaped support; the inner side of a side of the ring-shaped support facing away from the cover plate has anti-separation catches; and a plurality of the anti-separation fasteners can pass through the central hole of the ring-shaped support and be fitted and snapped on the anti-separation catches.

Alternatively, the end of the anti-separation fastener has a slope for guiding the cover plate to snap into the ring-shaped support.

According to a fifth aspect, the present invention provides an electrical motor fitted with an electrically conductive ring for bearing electrical corrosion protection according to the third aspect of the present invention or fitted with an electrically conductive ring for bearing electrical corrosion protection according to the fourth aspect of the present invention.

Alternatively, the electric motor further includes an electrically conductive ring provided on an electrically conductive ring for bearing electrical corrosion protection; an output shaft of the electric motor is mounted in the electrically conductive ring for bearing electrical corrosion protection; a front end of the electrically conductive fiber is in interference contact with the electric motor shaft, and a tail end of the electrically conductive fiber is in interference contact with the; including a ring-shaped support and a housing; the housing is matingly mounted to the ring-shaped support provided with at least one mounting groove in interference contact therewith; a body of the fiber retainer is in interference contact with the including a ring-shaped support and a housing; including a ring-shaped support and a housing; the housing is matingly mounted to the ring-shaped support provided with at least one mounting groove, and the mounting groove is in interference contact with the electric motor; the housing includes a ring-shaped support and a housing; the housing is be matingly mounted to the ring-shaped support; wherein the body of the fiber retainer, the includes a ring-shaped support and a housing; the ring-shaped support is provided with at least one mounting groove; and the mounting grooves each have electrical conductivity.

Compared with the prior art, the invention has at least the following beneficial effects.
1. In the prior art, it only has a radial restraint force and no axial restraint force on the electrically conductive fibers. In the present invention, the fiber retainer provides a radial restraining force in the axial direction to prevent the fiber bundle from falling, with the fixing portion thereof used to fix the wire fiber to provide an axial restraining force to prevent the fiber bundle from falling out. The fiber retainer is used to fix the electrically conductive fiber in a better way than the body of the shaft grounding bearing protection device is used to fix the electrically conductive fiber.
2. The present invention includes a ring-shaped support and a housing, wherein the housing is matingly mounted on the ring-shaped support; the ring-shaped support is provided with at least one mounting groove; the mounting groove and the ring-shaped support have an assembly structure, which has a simple assembly and fewer working procedures and is suitable for mass production to improve production efficiency.

### BRIEF DESCRIPTION OF THE DRAWINGS

FIG. 1 is a structurally schematic side view of a fiber retainer according to the present invention;

FIG. 2 is a structurally schematic cross-sectional view in the direction A-A of FIG. 1;

FIG. 3 is a schematic perspective view of a fiber retainer according to the present invention;

FIG. 4 is a schematic side view of a fiber retainer of the present invention after installation of electrically conductive fibers;

FIG. 5 is a structurally schematic cross-sectional view in the direction A-A of FIG. 4;

FIG. 6 is a structurally schematic top view of a ring-shaped support according to the present invention;

FIG. 7 is an enlarged view of a circled range in FIG. 6;

FIG. 8 is a structurally schematic top view of a cover plate;

FIG. 9 is a structurally schematic cross-sectional view in the direction A-A of FIG. 8;

FIG. 10 is a structurally schematic top view of the front side of the body assembled between the cover plate and the ring-shaped support assembly;

FIG. 11 is a structurally schematic cross-sectional view in the direction A-A of FIG. 10;

FIG. 12 is a structurally schematic top view of the reverse side of the body assembled between the cover plate and the ring-shaped support assembly;

FIG. 13 is a schematic perspective view of a fiber retainer in another embodiment;

FIG. 14 is a top view of FIG. 13;

FIG. 15 is a cross-sectional view taken along the line A-A of FIG. 14;

FIG. 16 is a schematic perspective view of another embodiment of electrically conductive fibers held by a fiber retainer;

FIG. 17A is a schematic cross-sectional view of the fiber retainer after the electrically conductive fiber is mounted, and FIG. 17B is a schematic cross-sectional view of another embodiment of the fiber retainer after the electrically conductive fiber is mounted;

FIG. 18 is a top view of a ring-shaped support in another embodiment.

FIG. 19 is a cross-sectional view of Fig. B-B;

FIG. 20 is a perspective view of FIG. 18.

### REFERENCE NUMERALS

body 1; fiber accommodating hole 11; first anti-separation ring 12; fiber fixing ring 13; second anti-separation ring 14; first stress groove 15; second stress groove 16; guiding end 17; electrically conductive fiber 2; ring-shaped support 3; anti-separation catch 31; mounting groove 32; front-end groove 321; intermediate groove 322; rear-end groove 323; cover plate 4; anti-release fastener 41; slope 411; dust ring 5; R angle 6; fixing portion 7; anti-separation portion 8; mounting groove 9; first recess 91; second recess 92.

### DETAILED DESCRIPTION OF THE INVENTION

The technical solutions in the embodiments of the invention will be described clearly and completely in conjunction with the accompanying drawings in the embodiments of the invention. Obviously, the described embodiments are only part of the embodiments of the invention, rather than all of the embodiments. Based on the embodiments in the invention, all other embodiments obtained by a person skilled in the art without involving any inventive effort are within the scope of protection of the invention.

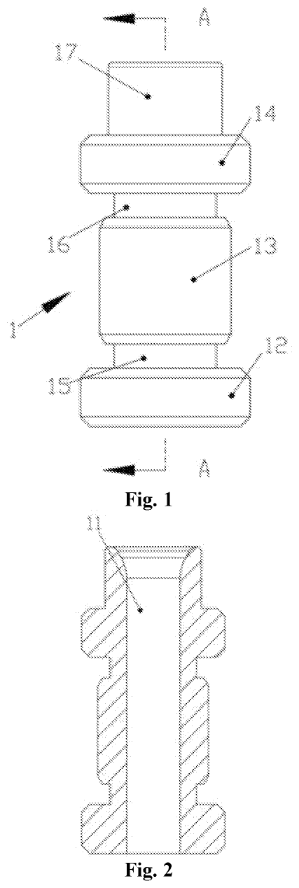

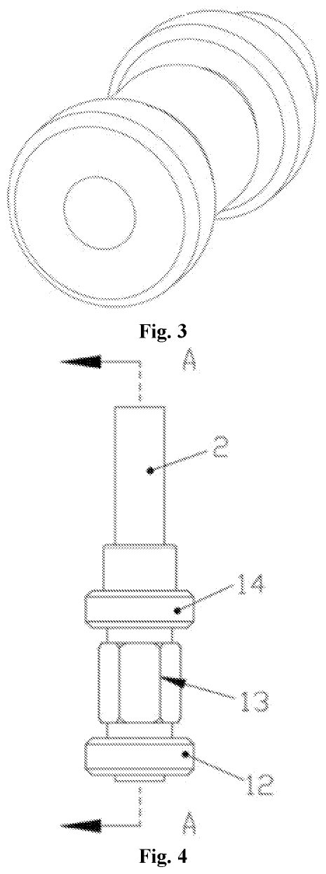

As shown in FIGS. 1 to 5, the present invention provides a fiber retainer, including a body 1 having a fiber accommodating hole 11 extending in a length direction for accommodating an electrically conductive fiber 22 (generally a fiber bundle); a first anti-separation ring 12, a fiber fixing ring 13 and a second anti-separation ring 14 are sequentially arranged in a circumferential direction of the body 1 in the length direction of the body 1; a first stress groove 15 is provided between the first anti-separation ring 12 and the fiber fixing ring 13; a second stress groove 16 is provided between the fiber fixing ring 13 and the second anti-separation ring 14; and the first stress groove 15 and the second stress groove 16 are both used for absorbing the deformation generated by pressing the fiber fixing ring 13.

The body 1 has a fiber accommodating hole 11 extending in the length direction for accommodating an electrically conductive ring 22. A first anti-separation ring 12, a fiber fixing ring 13 and a second anti-separation ring 14 are arranged in sequence along the circumferential direction of the body 1 along the length direction of the body 1. A first stress groove 15 is provided between the first anti-separation ring 12 and the fiber fixing ring 13. A second stress groove 16 is provided between the fiber fixing ring 13 and the second anti-separation ring 14. The first stress groove 15 and the second stress groove 16 are both used for absorbing the deformation generated by pressing the fiber fixing ring 13. When the electrically conductive fiber 22 is mounted, the electrically conductive fiber 22 extends from one end of the fiber accommodating hole 11 to the other end of the fiber accommodating hole 11. Preferably, the electrically conductive fiber 22 protrudes outside the other end of the fiber accommodating hole 11, and the tail end of the body 1 protrudes from the electrically conductive fiber 22 for buffering.

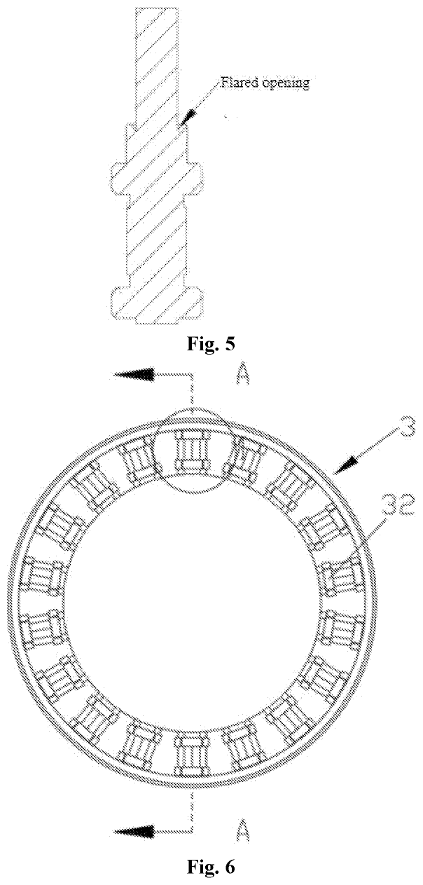

In practical applications, one end of the second anti-separation ring 14 away from the second stress groove 16 extends out of the guiding end 17. The fiber accommodating hole 11 in the guiding end 17 is in a flared shape, as shown in FIG. 5, for guiding the installation of the electrically conductive fiber 22. When the electrically conductive fiber 22 is mounted inside the body 1, the fiber fixing ring 13 is pressed by an external force so that the fiber fixing ring 13 is deformed and retracted towards the axis of the fiber accommodating hole 11 so as to compress and fix the electrically conductive fiber 22. At the same time, the deformation generated after the fiber fixing ring 13 is pressed and deformed is absorbed by the first stress groove 15 and the second stress groove 16, as shown in FIG. 4. FIG. 5 is a schematic view of the electrically conductive fibers 22 after being pressed and fixed.

The present invention also provides a electrically conductive ring for bearing electrical corrosion protection, including a ring-shaped support 3 and a cover plate 4, wherein the cover plate 4 can be matingly mounted on the ring-shaped support 3 and together enclose at least one mounting groove 32, wherein the mounting groove 32 is arranged along the radial direction of the ring-shaped support 3. In order to increase the function of preventing electro-corrosion, a plurality of mounting grooves 32 can be provided. The plurality of mounting grooves 32 are preferably uniformly arranged on the ring-shaped support 3.

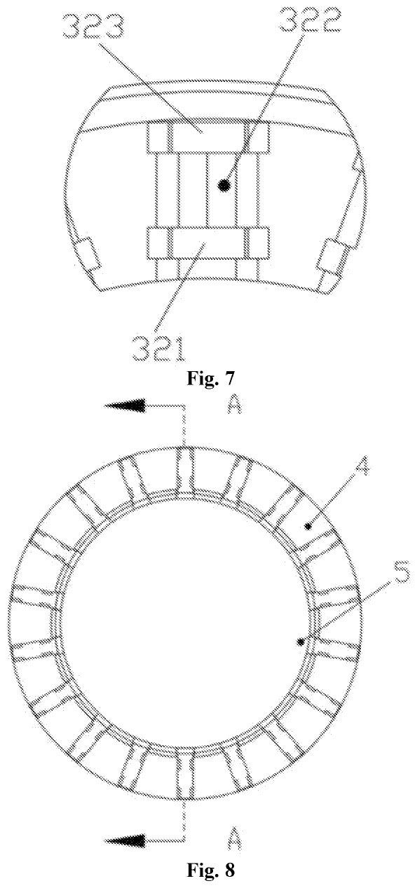

As shown in FIGS. 6 and 7, the mounting groove 32 is adapted to receive a fiber retainer, wherein the mounting groove 32 includes a front-end groove 321 adapted to receive the second anti-separation ring 14, an intermediate groove 322 adapted to receive the fiber fixing ring 13, and a rear-end groove 323 adapted to receive the first anti-separation ring 12.

Specifically, the outer diameters of the first and second anti-separation rings 12 and 14 are both greater than the outer diameters of other parts of the body 1, so that when the body 1 is mounted in the mounting groove 32, axial play is not allowed to occur, increasing the security after mounting. The outer diameters and shapes of the first and second anti-separation rings 12 and 14 are preferably the same.

Further, the shapes of the first anti-separation ring 12, the second anti-separation ring 14, the groove bottom of the first stress groove 15, and the groove bottom of the second stress groove 16 are all preferably a cylindrical structure. The fiber fixing ring 13 is a cylindrical structure before extrusion, and is preferably polygonal in cross section after extrusion.

In order to facilitate assembly, the ends of the first anti-separation ring 12, the fiber fixing ring 13 and the second anti-separation ring 14 are all chamfered. In practical applications, the cover plate 4 and the ring-shaped support 3 can be connected in various structures. The cover plate 4 can be fixed on the ring-shaped support 3 in various structural connection manners, such as screwing, clamping, welding or riveting.

Further, the present invention also provides an electric motor fitted with the electrically conductive ring for bearing electrical corrosion protection according to the present invention.

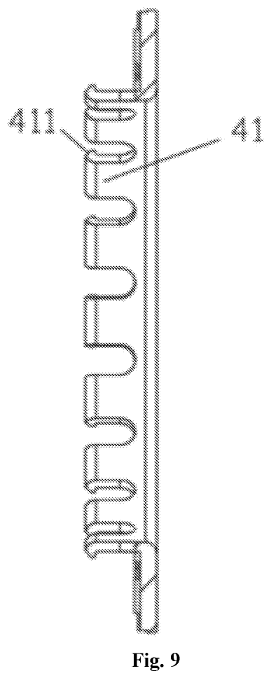

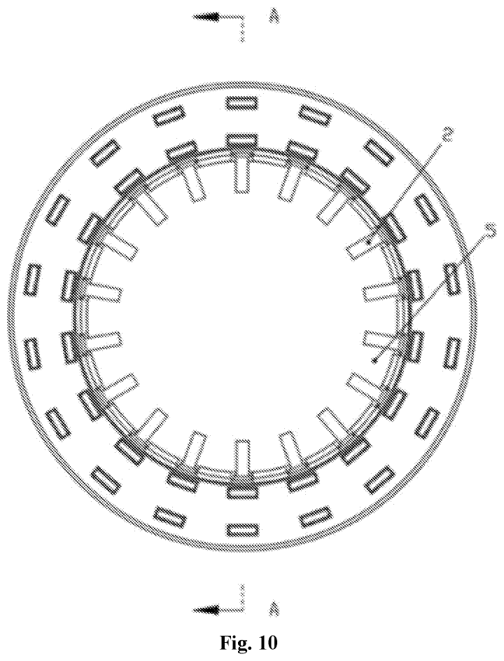

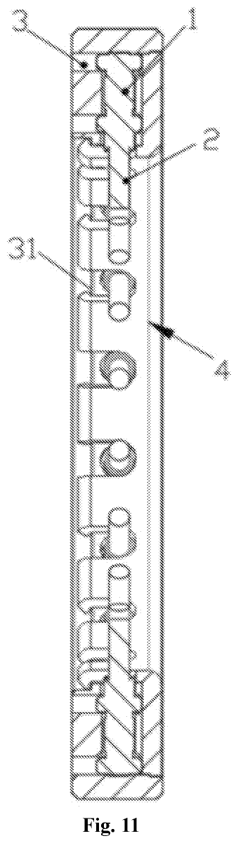

As shown in FIGS. 8, 9, 10, 11 and 12, in the electrically conductive ring for bearing electrical corrosion protection, the cover plate 4 extends with a plurality of anti-separation fasteners 41 arranged in an annular space towards one side of the ring-shaped support 3. The anti-separation fasteners 41 are elastic structures. The outer diameter of the annular formed by the plurality of anti-separation fasteners 41 is greater than the inner diameter of the inner hole of the ring-shaped support 3. Preferably, the outer diameter of the ring shape formed by the plurality of anti-separation fasteners 41 is slightly greater than the inner diameter of the inner hole of the ring-shaped support 3, so that the anti-separation fasteners 41 can elastically snap onto the ring-shaped support 3 when the cover plate 4 is fitted into the ring-shaped support 3. The inner side of the side of the ring-shaped support 3 facing away from the cover plate 4 is provided with an anti-separation catch 31. When the cover plate 4 is fitted to the ring-shaped support 3, a plurality of anti-separation fasteners 41 can pass through the central hole of the ring-shaped support 3 and be fitted and clamped on the anti-separation catch 31.

In the present embodiment, an end of the anti-release fastener 41 has a slope 411 guiding the cover plate 4 to snap into the ring-shaped support 3. The inner ring of the ring-shaped support 3 is further provided with a dust ring 5, and the electrically conductive fibers 22 extend towards one end of the center of the ring-shaped support 3 to the inside of the inner side of the dust ring 5, facilitating contact with the electro-eroded component and conducting electric charges away in time.

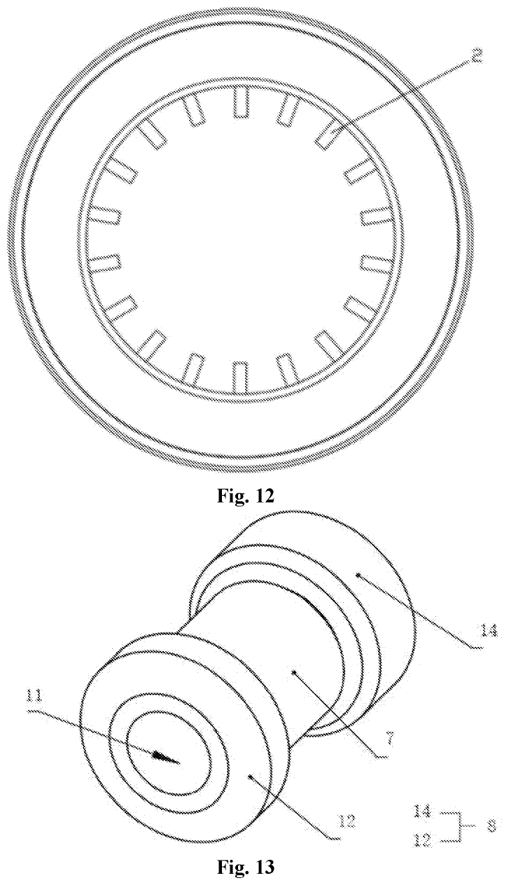

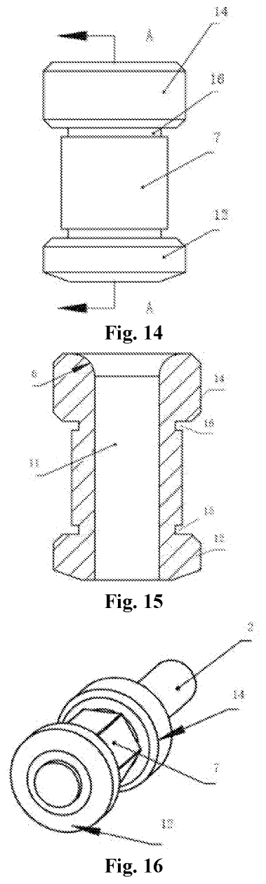

Referring to FIGS. 13 to 15, a fiber retainer according to another embodiment of the present invention includes: a body 1, wherein the body 1 has a fiber accommodating hole 11 provided therein in a lengthwise direction for accommodating an electrically conductive fiber 2, namely, the body 1 has a hollow structure.

The body 1 includes an anti-separation portion 8 and a fixing portion 7. The fixing portion 7 and the anti-separation portion 8 are respectively hollow structures. The fixing portion 7 and the anti-separation portion 8 communicate inside with each other to form a fiber accommodating hole 11 for accommodating the electrically conductive fibers 2. The anti-separation portion 8 is located substantially at the end of the body 1, and the fixing portion 7 is located slightly substantially at the middle of the body 1. Of course, the anti-separation portion 8 may be disposed substantially in the middle of the body 1, and the fixing portion 7 may be substantially adjacent to the middle of the body 1.

The fixing portion 7 and the anti-separation portion 8 constitute the main body 1, and the fixing portion 7 and the anti-separation portion 8 are preferably of an integral structure. Herein, the outer diameter of the anti-separation portion 8 is greater than the outer diameter of the fixing portion 7, and the anti-separation portion 8 can be used for interconnecting with an external conductive ring for supporting and fixing the body 1.

The fiber accommodating hole 11 extends through the body 1 or is a solid hole in the body 1. Illustratively, the fiber accommodating hole 11 is formed at least inside the fixing portion 7 and extends to an end of the body 1. The fiber accommodating hole 11 may extend completely through the body 1 or may simply be a cavity formed in the body 1, but does not extend through the body 1. The fixing portion 7 and the anti-separation portion 8 are cylindrical in the drawing, and may have other cylindrical shapes in other embodiments. The body 1 receives conductive fibers by means of fiber accommodating holes 11. The body 1 has a length, which provides a radial restraining force in the axial direction, preventing the fiber bundle from falling.

Illustratively, the fixing portion 7 is a cylinder or a polygonal cylinder. For example, in the case of a polygonal cylinder, the fixing portion 7 may have a semi-open structure with a U-shaped cross section. The fixing portion 7 is deformed by an external force so that an inner diameter of a portion of the fiber accommodating hole 11 is contracted to fix the electrically conductive fiber 2 in the body 1. Generally, the fiber fixer is made of a metal material and has electrical conductivity. The external force is usually squeezed, so that the fixing portion 7 is deformed after being pressed, and the aperture of the fiber accommodating hole 11 in the fixing portion 7 is contracted, thereby fixing the fiber in the fixing portion 7. The fixing portion 7 is deformed by an external force and has at least a polygonal cross-section. As shown in FIG. 16, the cylindrical fixing portion 7 is pressed to form a hexagonal pressing surface. It is of course also possible to press the fixing portion 7 directly so that it is deformed to cover and fix the electrically conductive fiber 2.

In the present invention, the fiber fixer fixes the wire fiber by deforming the fixing portion 7 of the fiber fixer to provide an axial restraining force. The fixing portion 7 fastens the electrically conductive fiber to prevent the bundle of the electrically conductive fiber from coming out, thereby making the wire fiber stronger.

Specifically, as shown in FIGS. 13 to 15, the anti-separation portion 8 includes a first anti-separation ring 12 and a second anti-separation ring 14, which are provided in front of and behind the body 1, respectively. The fixing portion 7 is located between the first anti-separation ring 12 and the second anti-separation ring 14.

Further, the anti-separation portion 8 includes a first anti-separation portion and a second anti-separation portion. The two portions may not be annular, or may have other shapes, and may be fixed with other structures, such as a polygonal shape, or a shape used for clamping, fastening, etc.

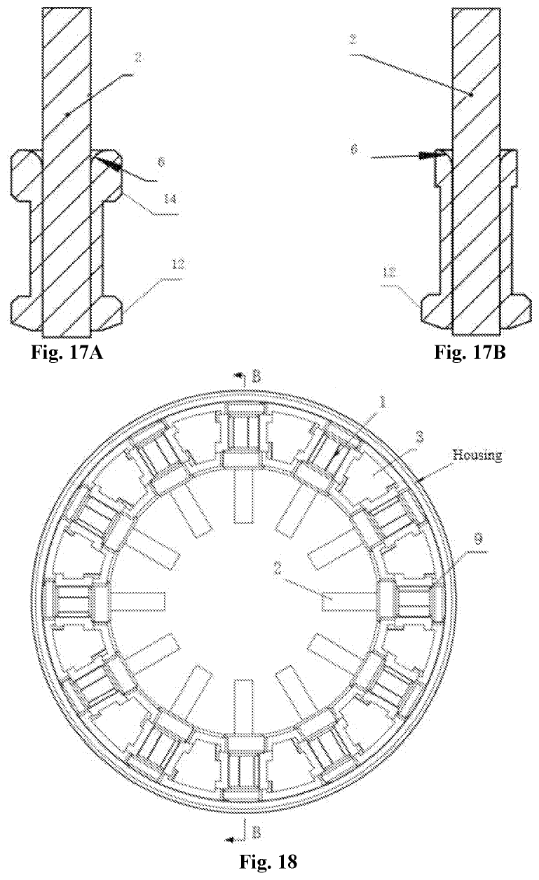

In other embodiments, as seen in FIG. 17B, the anti-separation portion 8 may be provided with only one, e.g., including only the first anti-separation ring 12.

In the embodiment including a first anti-separation portion and a second anti-separation portion, a first stress groove 15 is provided between the first anti-separation ring 12 and the fixing portion 7, a second stress groove 16 is provided between the fixing portion 7 and the second anti-separation ring 14, and both the first stress groove 15 and the second stress groove 16 (namely, an energy absorption groove) are used for absorbing deformation generated by pressing the fixing portion.

The present invention greatly improves the stability of the fiber retainer in the mounting groove 9 by designing the first anti-separation ring 12, the fixing portion 7, and the second anti-separation ring 14 on the body 1, and facilitates the assembly and improves the assembly efficiency.

Furthermore, an energy absorption groove is provided between the fixing portion 7 and the anti-separation portion 8, so as to reduce the product deformation and warpage, reduce the risk of fracture at the joint, and convert the shear direction force into front-rear extension force. In an alternative embodiment, the first stress groove 15 and the second stress groove 16 have a length ranging from 4 mm to 4.2 mm. It is of course also possible to correspondingly enlarge and reduce the aforesaid length range depending on the size requirements of the fiber retainer.

In order to prevent the fiber damage from falling off, the opening end of the fiber retainer is further provided with an R angle. In an embodiment, the opening end of the body 1 has an R angle. The electrically conductive fibers 2 extend outwardly from the opening end of the body 1. See the opening position shown in FIG. 2 (upper position). In a further embodiment, the second anti-separation ring 12 is located at the front end of the body 1, the opening end of the second anti-separation ring 12 having an angle R, see FIG. 15 (upper position). In short, the position where the electrically conductive fibers 2 extend out of the fiber retainer is provided with an angle R. Compared with the traditional C-angle, the C-angle is an obtuse angle formed between two lines. The C-angle is easy to make the fiber fall off, and the R-angle can prevent the fiber from being damaged and falling off.

Referring to FIG. 17, the fiber retainer further includes an electrically conductive fiber 2, and the fiber accommodating hole 11 extends through the body 1. At least one end of the electrically conductive fibers 2 extends outwardly along the length of the body 1. In FIG. 17, the electrically conductive fibers 2 extend beyond the front and rear ends of the fiber retainer. In other embodiments, the electrically conductive fibers 2 may extend only beyond the front end of the fiber retainer (upper part of FIG. 17).

The body 1 of the fiber retainer is electrically conductive, and the electrically conductive fibers 2 are also electrically conductive, so that the corrosion of the electrically conductive rings is prevented by the electrical conductivity of both. The description will be made in conjunction with the electrically conductive ring for bearing electrical corrosion protection and the electric motor.

With reference to FIGS. 8, 18 and 19, the present invention also provides an electrically conductive ring for bearing electrical corrosion protection (or electrically conductive ring), including a ring-shaped support 3 and a housing. The housing and the ring-shaped support 3 can adopt a variety of assembly structures, can be applicable to a variety of application scenarios, and has a strong practicality. The housing can be matingly mounted to the ring-shaped support 3, the ring-shaped support 3 being provided with at least one mounting groove 9 for holding the fiber retainer nested in the mounting groove 9.

In the figures, a plurality of mounting grooves 9 are provided. 12 are provided in the figure and respectively arranged along the circumference of the ring-shaped support 3 so that the fibers protrude inside the fiber retainer. The axial direction of the fiber retainer is approximately the same as the radial direction of the annular holder 3. The electrically conductive fibers 2 held by the fiber retainer are directed towards the axis of the ring-shaped support 3.

The mounting groove 9 includes a first recess 91 adapted to the fixing portion 7 of the fiber retainer and a second recess 92 adapted to the anti-separation portion 8 of the fiber retainer. The diameter of the second recess 92 is slightly greater than the diameter of the first recess 91, which is similar to the front-end groove 321 and rear-end groove 323 described above.

When the fiber retainer is fixed to the ring-shaped support 3, the second recess 92 is slightly larger in diameter than the first recess 91, so that the anti-separation portion 8 of the fiber retainer is caught in the portion of the second recess 92, and it is possible to prevent the entire fiber retainer from moving in the radial direction of the electrically conductive ring.

Further, the upper surface of the anti-separation portion 8 of the fiber fixer is slightly higher than the ring-shaped support 3. When the fiber fixer is fixed on the ring-shaped support 3, the surface of the anti-separation portion 8 of the fiber fixer is slightly higher than the upper surface of the ring-shaped support 3. The largest part of the circular diameter of the anti-separation portion 8 and the mounting groove 9 of the ring-shaped support 3 form a snap-like type for holding the terminal sleeve. The anti-separation portion 8 is in close contact with the housing, so as to prevent the anti-separation during movement. The upper part of the anti-separation portion 8 protrudes from the ring-shaped support 3, so as to fully contact the housing during assembly for the purpose of electrical conduction.

Further, the ring-shaped supports 3 may be multi-layered, and a plurality of ring-shaped supports 3 may be provided in an electrically conductive ring for bearing electrical corrosion protection.

After assembly, the electrically conductive fiber 2 is secured to the fiber retainer; and a tail end of the electrically conductive fiber 2 is in interference contact with the housing and a tail end of the fiber retainer is in interference contact with the housing.

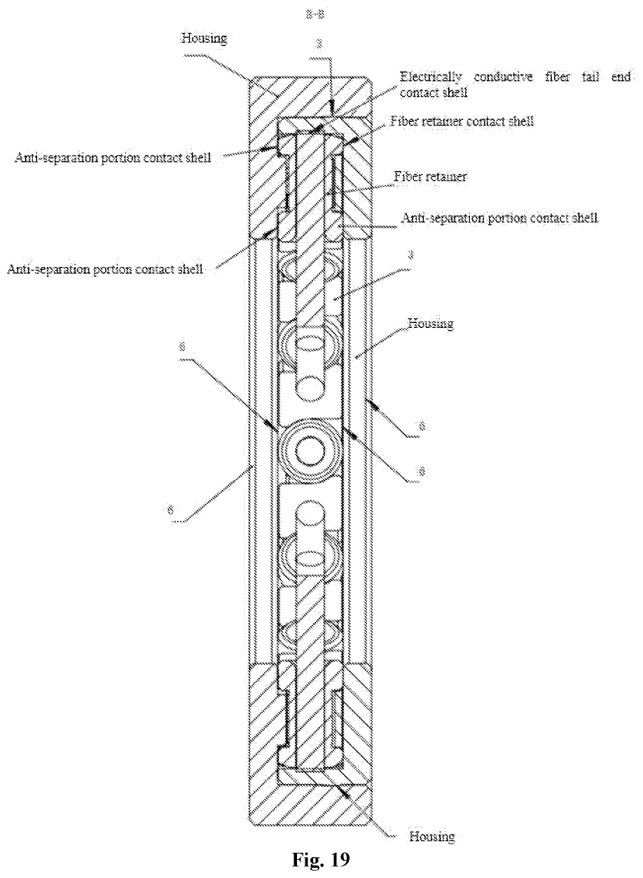

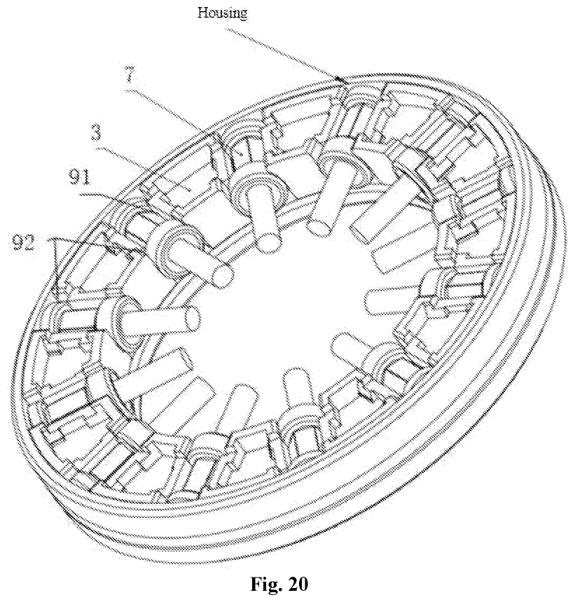

As shown in FIGS. 19 and 20, the length direction of the fiber retainer is directed to the center position of the electrically conductive ring, so that when the fiber retainer is arranged inside the ring-shaped support 3, the length direction of the electrically conductive fiber 2 coincides with the radial direction of the electrically conductive ring, and the tail end of the electrically conductive fiber 2 is also directed to the center position of the electrically conductive ring.

After the electrically conductive ring for bearing electrical corrosion protection is mounted on the electric motor, and an output shaft of the electric motor is arranged inside the electrically conductive ring. A tail end of the electrically conductive fiber 2 is in contact with the output shaft of the electric motor, a front end of the electrically conductive fiber 2 is in interference contact with the shaft of the electric motor, and a tail end of the electrically conductive fiber 2 is in interference contact with the housing of the metal. The fiber retainer is in close contact with the electrically conductive fiber 2, and the fiber retainer is in close contact with the housing of the electric motor. The housing is in interference contact with the outer surface of the electric motor. Therefore, the electric motor shaft forms a conductive loop with a low resistance with the electrically conductive fiber 2, the fiber retainer and the electric motor housing. When the electric motor is in use, the electric charge generated on the electric motor shaft can be easily conducted to the motor housing by the electrically conductive ring, and the electric charge does not accumulate between the motor bearings to form a high voltage potential, thereby reducing the risk of electric corrosion and prolonging the life of the motor bearings. Otherwise, the charge builds up in the bearing, forming electro-corrosion.

The present invention also provides an electric motor, which greatly improves the ease of assembly by providing a mounting groove 9 between the ring-shaped support 3 and the housing and fixing the electrically conductive fiber 2 by the fiber retainer having a shape matching the shape of the mounting groove 9, and which has a small number of mounting processes, simple processing and assembly, and facilitates mass production.

Specifically, the electric motor includes a housing, wherein the housing is provided with an electric motor and an electrically conductive ring 2 arranged on an electrically conductive ring for bearing electrical corrosion protection. An output shaft of the electric motor is mounted in the electrically conductive ring for bearing electrical corrosion protection. A front end of the electrically conductive fiber 2 is in interference contact with the electric motor shaft. A tail end of the electrically conductive fiber 2 is in interference contact with the housing. A body 1 of the fiber fixer is in interference contact with the housing, and the housing is in interference contact with the electric motor. The outer shell and the housing are connected, both being metal, and have electrical conductivity. Both the body 1 of the fiber retainer and the housing have electrical conductivity. The electric motor shaft forms a conductive loop with a low resistance with the electrically conductive fiber 2, the fiber retainer and the electric motor housing. When the electric motor is in use, the electric charge generated on the electric motor shaft can be easily conducted to the motor housing by the electrically conductive ring, and the electric charge does not accumulate between the motor bearings to form a high voltage potential, thereby reducing the risk of electric corrosion and prolonging the life of the motor bearings. Meanwhile, it provides a new structure scheme for the electrically conductive ring for bearing electrical corrosion protection.

The above embodiments are only intended to illustrate the technical solution of the invention, but not to limit it. Although the invention has been described in detail with reference to the foregoing embodiments, those skilled in the art will appreciate that the technical solutions of the above-mentioned embodiments can still be modified, or some of the technical features thereof can be equivalently substituted; and with such modifications and substitutions, the essence of the corresponding technical solutions does not depart from the spirit and scope of the embodiments of the invention.

1. A fiber retainer, comprising a body, wherein the body internally has a fiber accommodating hole provided along the length thereof, and the fiber accommodating hole is used for accommodating an electrically conductive fiber; the body comprises an anti-separation portion and a fixing portion, wherein the fixing portion and the anti-separation portion constitute the body, and the anti-separation portion has an outer diameter greater than that of the fixing portion; the fiber accommodating hole is formed at least inside the fixing portion and extends to an end of the body; and the fixing portion deforms after being subjected to an external force, so that an inner diameter of part of the fiber accommodating hole is reduced, thereby fixing the electrically conductive fiber in the body.

2. The fiber retainer according to claim 1, wherein the anti-separation portion is located substantially at an end of the body and the fixing portion is located substantially at a middle of the body.

3. The fiber retainer according to claim 1, wherein an open end of the body has an R angle; and the electrically conductive fibers extend outwardly from the open end of the body.

4. The fiber retainer according to claim 1, wherein the anti-separation portion comprises a first anti-separation ring and a second anti-separation ring; and the fixing portion is located between the first anti-separation ring and the second anti-separation ring.

5. The fiber retainer according to claim 4, wherein the second anti-separation ring is located at a front end of the body, and an open end of the second anti-separation ring has an R angle.

6. The fiber retainer according to claim 4, wherein a first stress groove is provided between the first anti-separation ring and the fixing portion; a second stress groove is provided between the fixing portion and the second anti-separation ring; and the first stress groove and the second stress groove are both used to absorb the deformation generated by pressing the fixing portion.

7. The fiber retainer according to claim 1, wherein the fixing portion is a cylinder or a polygonal cylinder.

8. The fiber retainer according to claim 1, wherein the fiber accommodating hole extends through the body or is a solid hole in the body.

9. The fiber retainer according to claim 1, wherein only one anti-separation portion is provided.

10. The fiber retainer according to claim 1, wherein the fixing portion is deformed by an external force and has at least a polygonal cross-section.

11. The fiber retainer according to claim 1, further comprising an electrically conductive fiber; the fiber accommodating hole extends through the body; at least one end of the electrically conductive fiber extends outwardly along the length of the body; and the body is electrically conductive.

12. A fiber retainer, comprising a body having a fiber accommodating hole extending in a length direction for accommodating an electrically conductive fiber; a first anti-separation ring, a fiber fixing ring, and a second anti-separation ring are sequentially arranged in a circumferential direction of the body in the length direction of the body; a first stress groove is provided between the first anti-separation ring and the fiber fixing ring; a second stress groove is provided between the fiber fixing ring and the second anti-separation ring; and the first stress groove and the second stress groove are both used for absorbing deformation generated by pressing the fiber fixing ring.

13. An electrically conductive ring for bearing electrical corrosion protection, comprising a ring-shaped support and a housing, wherein the housing is matingly mounted on the ring-shaped support; the ring-shaped support is provided with at least one mounting groove for fixing a fiber retainer; wherein the fiber retainer comprises:
a body having a fiber accommodating hole provided therein in a lengthwise direction for accommodating an electrically conductive fiber;
wherein the inner wall of the fiber accommodating hole is glued with the electrically conductive fiber so as to fix the electrically conductive fiber in the body; alternatively, at least a part of the body is deformed upon application of an external force such that an inner diameter of a part of the fiber accommodating hole contracts to secure the electrically conductive fiber within the body.

14. The electrically conductive ring for bearing electrical corrosion protection according to claim 13, wherein the mounting grooves are provided with a plurality of ones arranged along a circumference of the ring-shaped support; and an axial direction of the fiber retainer is substantially the same as a radial direction of the ring-shaped support.

15. The electrically conductive ring for bearing electrical corrosion protection according to claim 13, wherein the mounting groove comprises a first recess adapted to a fixing portion of the fiber retainer and a second recess adapted to an anti-separation portion of the fiber retainer.

16. The electrically conductive ring for bearing electrical corrosion protection according to claim 15, wherein the diameter of the second recess is slightly greater than the diameter of the first recess.

17. The electrically conductive ring for bearing electrical corrosion protection according to claim 13, wherein an upper surface of the anti-separation portion of the fiber retainer is slightly higher than the ring-shaped support, the anti-separation portion being in close contact with the housing.

18. The electrically conductive ring for bearing electrical corrosion protection according to claim 13, wherein the electrically conductive fiber is secured to the fiber retainer; and a tail end of the electrically conductive fiber is in interference contact with the housing and a tail end of the fiber retainer is in interference contact with the housing.

19. The electrically conductive ring for bearing electrical corrosion protection according to claim 13, comprising a plurality of ring-shaped supports arranged in layers within the electrically conductive ring for bearing electrical corrosion protection.

20. An electrically conductive ring for bearing electrical corrosion protection, comprising a ring-shaped support and a cover plate, the cover plate is matingly mounted to the ring-shaped support, the both being together enclosed to form at least one mounting groove which is arranged in a radial direction of the ring-shaped support; the mounting groove is used for fixing a fiber retainer; wherein the fiber retainer comprises:
a body having a fiber accommodating hole provided therein in a lengthwise direction for accommodating an electrically conductive fiber;
wherein the inner wall of the fiber accommodating hole is glued with the electrically conductive fiber so as to fix the electrically conductive fiber in the body; alternatively, at least a part of the body is deformed upon application of an external force such that an inner diameter of a part of the fiber accommodating hole contracts to secure the electrically conductive fiber within the body.

21. The electrically conductive ring for bearing electrical corrosion protection according to claim 20, wherein the cover plate extends with a plurality of anti-separation fasteners arranged in an annular space towards one side of the ring-shaped support; the inner side of a side of the ring-shaped support facing away from the cover plate has anti-separation catches; and a plurality of the anti-separation fasteners can pass through the central hole of the ring-shaped support and be fitted and snapped on the anti-separation catches.

22. The electrically conductive ring for bearing electrical corrosion protection according to claim 21, wherein the end of the anti-separation fastener has a slope for guiding the cover plate to snap into the ring-shaped support.

23. An electric motor, comprising an electrically conductive ring for bearing electrical corrosion protection, wherein the electrically conductive ring for bearing electrical corrosion protection comprises an ring-shaped support; a mounting groove is arranged in a radial direction of the ring-shaped support; the mounting groove is used for fixing a fiber retainer; wherein the fiber retainer comprises:
a body having a fiber accommodating hole provided therein in a lengthwise direction for accommodating an electrically conductive fiber;
wherein the inner wall of the fiber accommodating hole is glued with the electrically conductive fiber so as to fix the electrically conductive fiber in the body; alternatively, at least a part of the body is deformed upon application of an external force such that an inner diameter of a part of the fiber accommodating hole contracts to secure the electrically conductive fiber within the body.

24. The electric motor according to claim 23, further comprising an electrically conductive ring provided on an electrically conductive ring for bearing electrical corrosion protection, wherein an output shaft of the electric motor is mounted in the electrically conductive ring for bearing electrical corrosion protection; a front end of the electrically conductive fiber is in interference contact with the electric motor shaft; a tail end of the electrically conductive fiber is in interference contact with a housing of the electrically conductive ring for bearing electrical corrosion protection; and a body of the fiber retainer is in interference contact with the housing which is in interference contact with the electric motor; wherein the body of the fiber retainer and the housing are both electrically conductive.

25. The fiber retainer according to claim 2, wherein the anti-separation portion comprises a first anti-separation ring and a second anti-separation ring; and the fixing portion is located between the first anti-separation ring and the second anti-separation ring.

26. The fiber retainer according to claim 3, wherein the anti-separation portion comprises a first anti-separation ring and a second anti-separation ring; and the fixing portion is located between the first anti-separation ring and the second anti-separation ring.
